(19) United States
(12) Patent Application Publication
(10) Pub. No.: US 2017/0195129 A1
(43) Pub. Date: Jul. 6, 2017

(54) METHOD AND DEVICE TO CONTROL SECONDARY DEVICES

(71) Applicant: Lenovo (Singapore) Pte. Ltd., New Tech Park (SG)

(72) Inventors: Nathan J. Peterson, Durham, NC (US); Arnold S. Weksler, Raleigh, NC (US); John Carl Mese, Cary, NC (US); Russell Speight VanBlon, Raleigh, NC (US)

(21) Appl. No.: 14/987,965

(22) Filed: Jan. 5, 2016

(51) Int. Cl. H04L 12/28; H04L 29/12; H04L 29/08; H04W 4/00; H04L 12/24

(52) U.S. Cl. CPC H04L 12/2814; H04W 4/001; H04L 41/0846; H04L 67/141; H04L 61/1541; H04L 12/2812; H04L 2012/2841; H04L 2012/2849

(57) ABSTRACT

A computer implemented method, device and computer program device are provided that are under control of one or more processors configured with specific executable program instructions. The method, device and computer program capture target descriptive data utilizing a base device, where the target descriptive data is representative of a secondary device. The method, device and computer program further initiate a network session with a network resource having control content associated with the secondary device and downloads the control content from the network resource to the base device. The control content is configured to be implemented on the base device in connection with controlling one or more operations of the secondary device.

### FIELD

The present disclosure relates generally to utilizing a base electronic device in connection with managing one or more secondary electronic devices.

### BACKGROUND OF THE INVENTION

More and more mobile devices are offered with the ability to control other electronics within a household or business. For example, a mobile device may utilize an application that controls other electronic devices that communicate over a local network, such as through Wi-Fi or other wireless network based links. As another example, a mobile device may be provided with an infrared (IR) transmitter that is managed to generate control codes for other electronic devices that include IR receivers. Typically, in order to afford control by a mobile device over another electronic device, the user is required to navigate to an appropriate website and download a related application. For example, when a user desires to control a new electronic device, such as an Amazon echo device, the user must navigate their mobile device to a website that offers companion mobile applications. The user must then select the appropriate version of the application to be downloaded.

However, it is not always clear whether a user needs to download a separate application to access and manage a secondary device. Further, it is not always clear where the user should go to obtain the appropriate application. Instead, with current solutions, the user first reads documentation that is provided with a new electronic device or provided online to determine whether an application needs to be downloaded, and if so where to obtain the application and which version to utilize. For example, to utilize an IR transmitter within a mobile device, the user first downloads an IR application and hope that the IR application includes the appropriate control codes and methods to control the electronic device.

Other existing solutions offer a dedicated remote control device (to be used separate and independent of a mobile device, such as a smart phone and the like). In some instances, a macro-based remote control unit is provided with pre-programming to afford control of many types of electronic devices. However, the preprogrammed information may not cover a particular electronic device that the user desires to control. Accordingly, the remote control device must be reprogrammed.

A need remains for improved methods and devices that facilitate management of secondary electronic devices by another user device.

### SUMMARY

In accordance with embodiments herein, a computer implemented method is provided that is under control of one or more processors configured with specific executable program instructions. The method captures target descriptive data utilizing a base device, where the target descriptive data is representative of a secondary device. The method further initiates a network session with a network resource having control content associated with the secondary device and downloads the control content from the network resource to the base device. The control content is configured to be implemented on the base device in connection with controlling one or more operations of the secondary device.

Optionally, the method further comprises analyzing the target descriptive data to identify a device identifier indicative of the secondary device and indicative of the network resource having the control content. The analyzing includes determining, from the target descriptive data, the one or more network resources that include the control content. The analyzing includes transmitting a request to a remote device management server for an address of the one or more network resources.

Optionally, the capturing of target descriptive data may include collecting image data representative of an image of the secondary device. The capturing of target descriptive data may include collecting data from communications data received from the secondary device. The control content may include an application that, when operated on the base device, enables control over the secondary device. The analyzing may include utilizing a catalog of network resource addresses to identify the one or more network resources.

In accordance with embodiments herein, a device is provided comprising a processor and a memory storing program instructions accessible by the processor. The device is responsive to execution of the program instructions. The processor captures target descriptive data utilizing a base device, where the target descriptive data is representative of a secondary device, initiates a network session with a network resource having control content associated with the secondary device and downloads the control content from the network resource to the base device, the control content configured to be implemented on the base device in connection with controlling one or more operations of the secondary device.

Optionally, the device may further comprise a camera that captures image data representative of the secondary device. The image data may correspond to the target descriptive data. A transceiver may be configured to transmit an inquiry request and may receive a response from the secondary device. The processor may analyze the response to obtain communications data corresponding to the target descriptive data. The processor may analyze the target descriptive data to identify a device identifier indicative of the secondary device and indicative of the network resource having the control content. The processor may determine, from the target descriptive data, the one or more network resources that include the control content.

Optionally, the device may further comprise a transceiver configured to transmit a request to a remote device management server for an address of the one or more network resources. The memory stores the control content including an application that, when operated by the processor, enables control over the secondary device. The memory stores a catalog of network resource addresses, the processor utilizing the catalog to identify the one or more network resources.

In accordance with embodiments herein, a computer program product is provided comprising a non-signal computer readable storage medium comprising computer executable code to capture target descriptive data utilizing a base device, where the target descriptive data is representative of a secondary device. The computer program product initiates a network session with a network resource having control content associated with the secondary device and downloads the control content from the network resource to the base device, the control content configured to be implemented on the base device in connection with controlling one or more operations of the secondary device.

Optionally, the computer executable code may further comprise analyzing the target descriptive data to identify a device identifier indicative of the secondary device and indicative of the network resource having the control content. The analyzing may include determining, from the target descriptive data, the one or more network resources that include the control content. The computer program product may further comprise the control content that includes an application that, when operated on the base device, enables control over the secondary device.

### BRIEF DESCRIPTION OF THE DRAWINGS

FIG. 1 illustrates a block diagram of a system for supporting management of secondary devices by one or more base devices in accordance with embodiments herein.

FIG. 2 illustrates a simplified block diagram of the base device of FIG. 1 in accordance with an embodiment.

FIG. 3 is a functional block diagram illustrating the hardware configuration of a base device implemented in accordance with an alternative embodiment.

FIG. 4 illustrates a process for initiating management, by a base device, over a secondary device in accordance with embodiments herein.

FIG. 5 illustrates a process for capturing and identifying image data, as the target descriptive data, in accordance with embodiments herein.

FIG. 6 illustrates a process for capturing and identifying communications data, as the target descriptive data, in accordance with embodiments herein.

FIG. 7 illustrates a process for determining an address of a network resource that includes control content for a secondary device of interest in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

In accordance with embodiments herein, methods and devices are provided that facilitate automated access and management, by a base device, over one or more electronic secondary devices. For example, the principles described herein may be implemented by a base device in connection with a new electronic secondary device when initially unboxed or otherwise activated, or in connection with an existing electronic secondary device. The base device obtains target descriptive data identifying the secondary device, such as through the use of a camera built into the base device, through data collected from communications transmitted from a secondary device or otherwise. The methods and devices utilize the target descriptive data to determine specific identification information regarding the secondary device (referred to as device identifiers).

The terms “base device”, “mobile device” and “user device”, as used throughout, refer to a device that has control content installed thereon in order to at least partially manage/control one or more operations of an electronic secondary device.

For example, when a user initially unboxes is or otherwise activates a new secondary device (e.g., an Amazon Echo device), the user may point his/her mobile phone or other base device at the new secondary device and provide a command to capture target descriptive data (e.g. by selecting an option on the base device or speaking a verbal command, such as “Control It”). In response to the instruction, the base device uses one or more data collection sources to collect the target descriptive data. For example, the base device may utilize a camera unit to capture a picture of the secondary device. Additionally or alternatively, the mobile phone may utilize a transceiver to search for wireless communications from the secondary device, such as over a Bluetooth channel or other wireless communications medium. The target descriptive data is then analyzed to obtain one or more device identifiers. For example, image data may be analyzed utilizing image recognition software. As another example, communications data (e.g. as received over a Bluetooth channel) may be analyzed to identify header information of interest.

Based on the device identifier(s), the methods and devices determine what, if any, additional software or other content is to be used in connection with accessing or controlling the electronic secondary device. For example, based on the device identifier, the methods and devices herein may determine that indicate that control content (e.g. a software application) is available for download to be used in connection with controlling the electronic secondary device. Based on the device identifiers, one or more network resource addresses may be identified, at which the software application or other control content is located and available for download. Additionally or alternatively, the device identifier may yield less specific information, such as a general indication regarding product information (e.g. make and model). The general product information may then be utilized to search for one or more network resources that include, support or provide general information regarding how to locate any software applications or other control content that would enable the base device to access or gain control over the secondary electronic device. For example, continuing the Amazon Echo product example, the base device, after identifying the product, would navigate to a webpage or other network location, at which a companion application has been registered for the Amazon Echo product. The companion application is downloaded and made available to launch on the base device in connection with controlling the electronic secondary product.

As another example, the methods and devices herein may be utilized by base devices having an IR transmitter in connection with controlling secondary electronic devices that are responsive to incoming IR communications. In the present example, the user would again point their base device at the television or other secondary device to be controlled through IR and direct the base device to collect target descriptive data. Once the secondary device is identified, the base device navigates online to a network location at which associated IR control codes are stored. After loading the IR control codes, the user may now utilize the base device as a remote control. The foregoing operations relieve the user of the need to learn codes or pick individual makes and models of electronic devices.

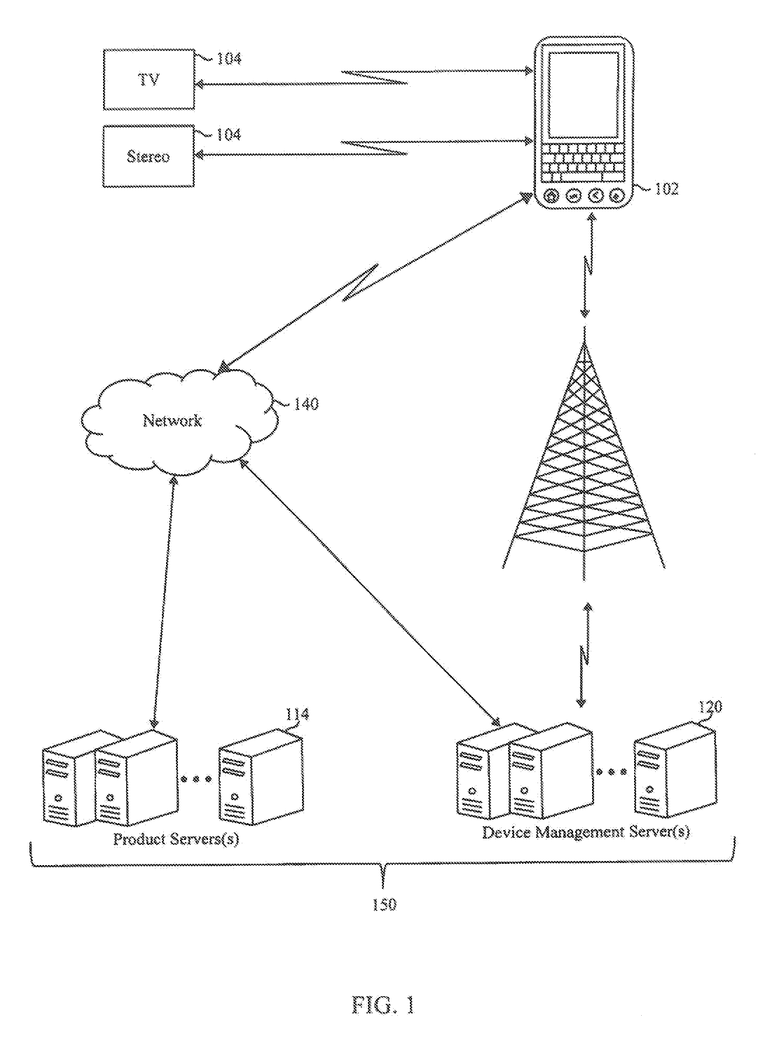

FIG. 1 is a block diagram of a system for supporting management of secondary devices by one or more base devices in accordance with embodiments herein. The system includes a base device 102, one or more secondary devices 104, one or more device management servers 120, and one or more product servers 114. By way of example, the base device 102 may be a mobile device, such as a cellular telephone, smartphone, tablet computer, personal digital assistant, laptop/desktop computer, gaming system, a media streaming hub device or other electronic terminal that includes a user interface and is configured to access a network 140 over a wired or wireless connection. As non-limiting examples, the base device 102 may access the network 140 through a wireless communications channel and/or through a network connection (e.g. the Internet). Optionally, the base device 102 may be responsive to voice commands. Additionally or alternatively, the base device 102 may be a wired or wireless communication terminal, such as a desktop computer, laptop computer, network-ready television, set-top box, and the like. The base device 102 may be configured to access the network using a web browser or a native application executing thereon. In some embodiments, the base device 102 may have a physical size or form factor that enables it to be easily carried or transported by a user, or the base device 102 may have a larger physical size or form factor than a mobile device.

The secondary device 104 may represent the same or different type of device as the base device 102, such as a tablet computer, mobile phone, personal digital assistant, laptop/desktop computer and the like. In addition, other non-limiting examples of secondary devices 104 include televisions, stereos, home appliances, network devices (e.g. routers, hubs, etc.), remote-controlled electronic devices, a wearable device such as a smart watch or smart glasses, home automation electronic hubs (e.g. the Amazon Echo device), content management and streaming devices (e.g. the Chrome Cast device, Roku device, Kire TV stick device, Sonos devices), video games, cameras, camcorders, drones, toys, home theater systems, automobiles, GPS systems, audio content players and the like.

The base device 102 (and optionally the secondary devices 104) are configured to communication over the network 140 with various types of network resources. Examples of network resources include one or more product servers 114 and one or more device management servers 120. The product servers 114 may be maintained by manufacturers, distributors, wholesale or retail sellers, as well as other entities in connection with supporting or otherwise offering control content for the secondary devices 104. The device management servers 120 may be managed and operated by base device manufacturers, distributors, retailers, marketers or otherwise. Additionally or alternatively, the device management servers 120 may be managed and operated by a third-party service. The product and device management servers 114 and 120 are collectively referred to as network resources 150.

The base device 102 is configured to access network resources 150, including web-based or network-based data, applications, and services, via the network 140. The network 140 may represent one or more of a local area network (LAN), a wide area network (WAN), an Intranet or other private network that may not be accessible by the general public, or a global network, such as the Internet or other publicly accessible network. The network 140 provides communication between the base device 102 and one or more network resources 150. The online resources 150 (including the product and device management servers 114 and 120) include one or more network transceiver, processor, memory, and/or other circuitry configured to coordinate and manage operations as described herein.

It will be understood that, in some embodiments, the network resources 150 may represent a single entity or one or more physical or virtual servers that are configured to deliver online resources to the base device 102. Examples of the network resources 150 include, but are not limited to, web-based or network-based data storage services, social networking applications, shopping services, microblogging accounts, payment services, multimedia content delivery services, financial services and the like. The resource 150 may represent a Web service or a network service for an e-commerce business, financial institution, or any other commercial, noncommercial, personal, nonprofit or other entity.

In the example of FIG. 1, the base device 102 represents a cellular telephone that communicates with a cellular network over one or more communications channels 142. The communication between the base device 102 and the cellular network may be unidirectional or bidirectional. A communications channel 142 may be provided by any communications provider, such as any source that disseminates information. The network 140 and communications channel 142 may be physically/logically separate channels. Optionally, the network 140 and communications channel 142 may be separate channels over the same underlying network.

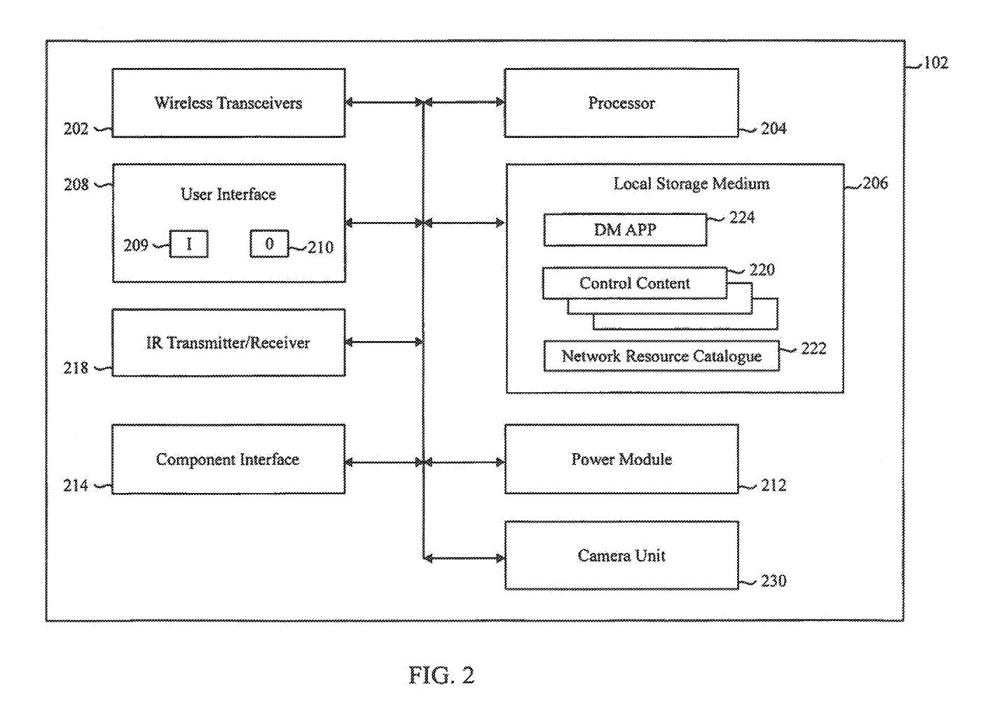

FIG. 2 illustrates a simplified block diagram of the base device 102 of FIG. 1 in accordance with an embodiment. The base device 102 includes components such as one or more wireless transceivers 202, one or more processors 204 (e.g., a microprocessor, microcomputer, application-specific integrated circuit, etc.), one or more local storage medium (also referred to as a memory portion) 206, a user interface 208 which includes one or more input devices 209 and one or more output devices 210, a power module 212, a component interface 214 and a camera unit 230. All of these components can be operatively coupled to one another, and can be in communication with one another, by way of one or more internal communication links, such as an internal bus. The camera unit 230 may capture one or more frames of image data.

The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof.

The user interface 208 permits the user to select one or more of a switch, button or icon to collect target designation data, and/or enter indicators to direct the camera unit 230 to take a photo or video (e.g., capture image data). As another example, the user may select a content collection button on the user interface 208 two or more successive times, thereby instructing the base device 102 to capture the image data.

As another example, the user may enter one or more predefined touch gestures and/or voice command through a microphone on the base device 102. The predefined touch gestures and/or voice command may instruct the base device 102 to collect image data for a scene and/or a select object in the scene.

The local storage medium 206 can encompass one or more memory devices of any of a variety of forms (e.g., read only memory, random access memory, static random access memory, dynamic random access memory, etc.) and can be used by the processor 204 to store and retrieve data. The data that is stored by the local storage medium 206 can include, but need not be limited to, operating systems, applications, user collected content and informational data. Each operating system includes executable code that controls basic functions of the device, such as interaction among the various components, communication with external devices via the wireless transceivers 202 and/or the component interface 214, and storage and retrieval of applications and data to and from the local storage medium 206. Each application includes executable code that utilizes an operating system to provide more specific functionality for the communication devices, such as file system service and handling of protected and unprotected data stored in the local storage medium 206.

The local storage medium 206 stores various content including, but not limited to, a device management (DM) application 224, controlled content 220, one or more network resource catalogs 222 and the like. The device management (DM) application 224 for facilitating the management of one or more operations of the secondary devices 104 by the base device 102. The DM application 224 includes program instructions accessible by the one or more processors 204 to direct a processor 204 to implement the methods, processes and operations described herein including, but not limited to the methods, processes and operations illustrated in the Figures and described in connection with the Figures. Additionally, the local storage medium/memory 206 stores image data 216, target descriptive data, device identifiers, network resource addresses, control content and the like.

Among other things, the DM application 224 manages operation of the processor 204 in connection with capturing target descriptive data representative of secondary devices. For example, the processor 204 may manage operation of a camera unit 230 in connection with collecting image data and/or may manage operation of the transceiver 202 in connection with collecting communications data, where the image and communications data represent different examples of target descriptive data. The DM application 224 may further manage the processor 204 to analyze the image data utilizing image recognition software in order to determine a device identifier indicative of the secondary device captured by the image data. The DM application 224 may also manage the processor 204 to analyze the communications data, such as by identifying header information of interest, to determine a device identifier indicative of a secondary device that transmitted be communications data.

The DM application 224 directs the processor 204 to utilize the device identifier to determine one or more network resource addresses that may contain control content associated with the secondary device. For example, the DM application 224 may direct the processor 204 to access the network resource catalog 224 and compare the device identifier with the content of the network resource catalog 224 in search of a matching network resource address. As explained herein, when a matching network resource address is identified, the DM application 224 then directs the processor 204 to initiate a network session with the network resource at the corresponding address and to download control content 220 there from. Alternatively, when the catalog 224 does not include a matching network resource address, the DM application 224 directs the processor 204 to communicate with a remote service (e.g. the device management servers 120 in FIG. 1). The processor 204 provides the device identifier to the remote service and request and associated network resource address. When a network resource address is returned from the remote service, the processor 204 downloads the corresponding control content 220. Once downloaded, the control content 220 is configured to be implemented by the processor 204 in connection with controlling one or more operations of the secondary device.

Other applications stored in the local storage medium 206 include various application program interfaces (APIs), some of which provide links to/from the cloud hosting service. The power module 212 preferably includes a power supply, such as a battery, for providing power to the other components while enabling the base device 102 to be portable, as well as circuitry providing for the battery to be recharged. The component interface 214 provides a direct connection to other devices, auxiliary components, or accessories for additional or enhanced functionality, and in particular, can include a USB port for linking to a user device with a USB cable.

Each transceiver 202 can utilize a known wireless technology for communication. Exemplary operation of the wireless transceivers 202 in conjunction with other components of the base device 102 may take a variety of forms and may include, for example, operation in which, upon reception of wireless signals, the components of base device 102 detect communication signals from secondary devices and the transceiver 202 demodulates the communication signals to recover incoming information, such as responses to inquiry requests, voice and/or data, transmitted by the wireless signals. The processor 204 formats outgoing information and conveys the outgoing information to one or more of the wireless transceivers 202 for modulation to communication signals. The wireless transceiver(s) 202 convey the modulated signals to a remote device, such as a cell tower or a remote server (not shown).

In accordance with the embodiments of FIG. 6, the processor 204 directs the transceiver 202 to transmit an inquiry request and listen for responses from secondary devices. The processor 204 analyzes the header or other portions of the response to collect target descriptive data (e.g., device name, make model, version, etc.). The processor analyzes the data from the response to obtain a device identifier indicative of the secondary device. The processor 204 also performs some or all of the remaining operations described in FIGS. 4-7 to identify network resources, download control content and implement the control content to control one or more operations of the secondary device.

Optionally, the device 102 may include an infrared (IR) transmitter/receiver 218 that may be utilized in connection with controlling one or more secondary devices through transmission and reception of IR signals.

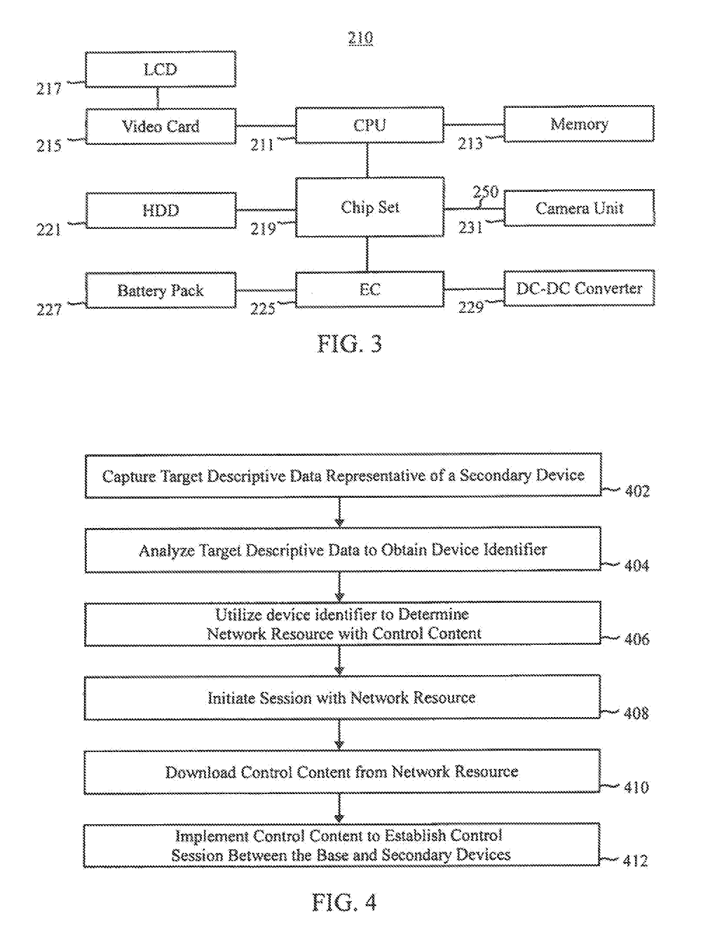

FIG. 3 is a functional block diagram illustrating the hardware configuration of a base device 210 implemented in accordance with an alternative embodiment. The CPU 211 includes a memory controller and a PCI Express controller and is connected to a main memory 213, a video card 215, and a chip set 219. An LCD 217 is connected to the video card 215. The chip set 219 includes a real time clock (RTC) and SATA, USB, PCI Express, and LPC controllers. A HDD 221 is connected to the SATA controller. A USB controller is composed of a plurality of hubs constructing a USB host controller, a route hub, and an I/O port.

A camera unit 231 may be a USB device compatible with the USB 2.0 standard or the USB 3.0 standard. The camera unit 231 is connected to the USB port of the USB controller via one or three pairs of USB buses, which transfer data using a differential signal. The USB port, to which the camera device 231 is connected, may share a hub with another USB device. The USB port may be connected to a dedicated hub of the camera unit 231 in order to effectively control the power of the camera unit 231 by using a selective suspend mechanism of the USB system. The camera unit 231 may be of an incorporation type in which it is incorporated into the housing of the note PC or may be of an external type in which it is connected to a USB connector attached to the housing of the note PC.

The system 210 includes hardware such as the CPU 211, the chip set 219, and the main memory 213. The system 210 includes software such as a DM application in memory 213, device drivers of the respective layers, a static image transfer service, and an operating system. An EC 225 is a microcontroller that controls the temperature of the inside of the housing of the computer 210 or controls the operation of a keyboard or a mouse. The EC 225 operates independently of the CPU 211. The EC 225 is connected to a battery pack 227 and a DC-DC converter 229. The EC 225 is further connected to a keyboard, a mouse, a battery charger, an exhaust fan, and the like. The EC 225 is capable of communicating with the battery pack 227, the chip set 219, and the CPU 211. The battery pack 227 supplies the DC-DC converter 229 with power when an AC/DC adapter (not shown) is not connected to the battery pack 227. The DC-DC converter 229 supplies the device constructing the computer 210 with power.

Next, exemplary embodiments are described in connection with implementing the operations herein. The operations of FIGS. 4-7 may be implemented by one or more processors within the-based devices 102, 210 and/or by the device management server 120.

FIG. 4 illustrates a process for initiating control/management, by a base device, over a secondary device in accordance with embodiments herein. At 402, the base device captures target descriptive data representative of the secondary device. As explained hereafter in more detail, the target descriptive data may be collected in various manners, such as by collecting image data for one or more images of the secondary device. As another example, the target descriptive data may be collected from metadata, header data or other communications data that is transmitted by the secondary device over one or more wireless medium. Optionally, the target descriptive data may be manually entered by the user, such as by typing in the data, orally speaking the data and the like.

At 404, a processor analyzes the target descriptive data to identify a device identifier. By way of example, the device identifier may include general product information, such as device name for the device. Optionally, the device identifier may include more specific product information, such as make, model, version, serial number and the like.

At 406, the processor utilizes the device identifier to determine one or more network resources that include control content associated with the secondary device. For example, the processor may utilize the device identifier to access a database or a catalogue 222 (FIG. 2) that includes network resource address information, such as specific URL links leading to desired control content. Additionally or alternatively, the device identifier may designate a more general address of a network resource (e.g. a general support webpage for a manufacturer or distributor of the secondary device). The processor may access the general support webpage and provide a request thereto for a link to a webpage associated with a particular make and model of a secondary device. The operations at 406 may be performed entirely or partially by the processor of the base device 102, 210. Additionally or alternatively, the operations at 406 may be performed entirely or partially by one or more processors at a remote resource such as a device management server (120 in FIG. 1).

At 408, the processor initiates a network session with the one or more network resources designated to have control content associated with the secondary device. The network session may be initiated with a network resource that is directly associated with the secondary device. For example, the network session may be initiated with a product server 114 (FIG. 1) associated with a manufacturer, distributor, retailer or other entity that supports a secondary device of interest. Optionally, the network session may be initiated with a third-party network resource that is utilized to identify more detailed information regarding the secondary device, such as the type, nature and/or location of an application or other content to be downloaded to the base device in connection with accessing or controlling the secondary device. For example, the network session may be initiated with the device management server 120 that identifies a network resource link associated with a particular secondary device. The device management server 120 returns the network resource link (e.g. URL) to the base device 102 which then initiates a network session with the product server 114 associated with the network resource link.

At 410, the control content is downloaded to the base device. The control content may include various types of content, where at least a portion of the control content is configured to be implemented on the base device in connection with initiating management of one or more operations of the secondary device. For example, the control content may include control software of interest, such as an application that, when operated on the base device, enables control/management over one or more operations of the secondary device.

Optionally, the base device may have an IR transmitter to be used in connection with controlling other electronic secondary devices that are responsive to incoming IR communications directions. For example, the base device may determine from the device identifier that the secondary device represents an IR controlled electronic device. Once the secondary device is identified, the base device navigates online to a network location at which associated IR control codes are stored. After loading the IR control codes, the user may now utilize the base device as a remote control. The foregoing operations relieve the user of the need to learn codes or manually enter individual makes and models of electronic devices.

At 412, the base device establishes a control session to access and control one or more operations of the secondary device.

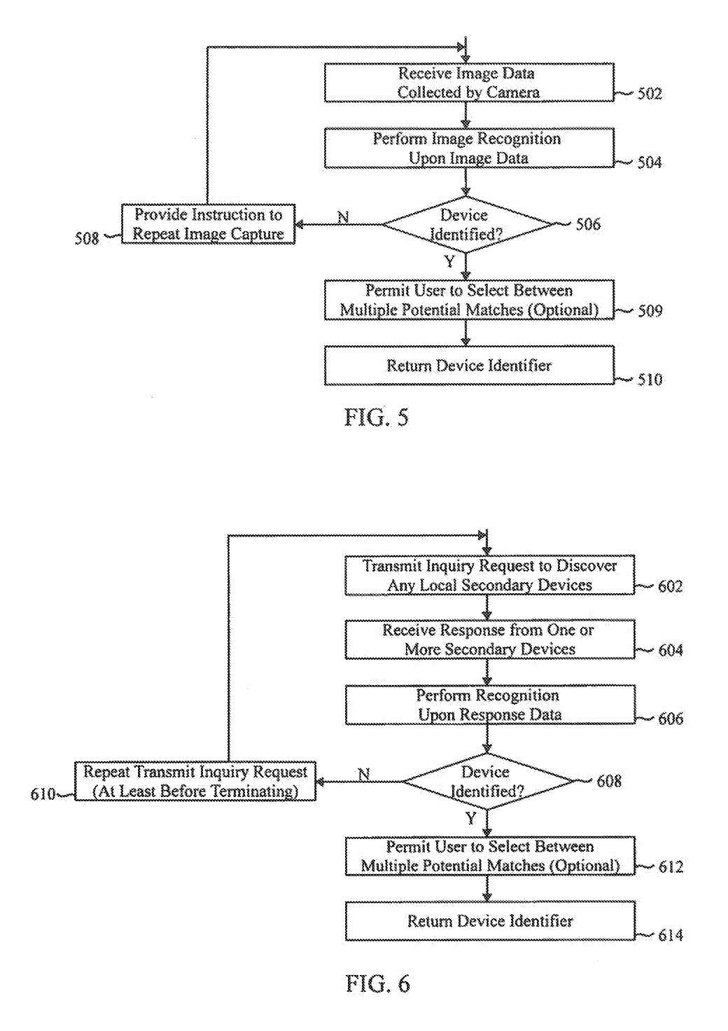

FIG. 5 illustrates a process for capturing and identifying image data, as the target descriptive data, in accordance with embodiments herein. At 502, image data is collected by a camera (e.g., camera unit 230 and FIG. 2 or 231 in FIG. 3). The image data may represent one or more still images, one or more videos and the like. The camera may be physically housed within the base device or may be separate therefrom, but coupled to communicate wirelessly or wired with the base device to convey image data to the base device. For example, a user may utilize a smart phone, tablet device or other electronic base device to take one or more pictures of the secondary device.

At 504, the image data is analyzed utilizing one or more conventional image recognition techniques. For example, one known image recognition technique may be Google goggles that enables a picture to be identified. Optionally, an image capture application may be loaded on the base device that is operated in connection with conventional image recognition software. For example, the image capture application may direct the user to take particular views of the secondary device (e.g. a front view of the front panel, a close-up view of a nameplate or serial number). As another example, the image data may represent an image of a barcode or QR code. A QR Code is a two-dimensional barcode that is readable by smartphones, tablet devices and the like. By way of example, a QR code may encode over 4000 characters in a two dimensional barcode. As one example, the QR code may identify a URL, device make, model, version number and the like. To read QR codes, appropriate software is installed on the base device. For example, Android-based devices may use Barcode Scanner by Zxing or numerous other applications. iOS-Devices may obtain various QR Code readers available on the App Store. As another example, a tablet device, a laptop or desktop computer may utilize a webcam to scan QR Codes.

At 506, the processor determines whether a device identifier was recognized from the image data. When no device identifier is obtained, flow moves to 508, where a message is presented to request/instruct the user to repeat the image capture operation. By way of example, at 508, suggestions may be provided to the user to better facilitate the collection of image data. For example, a message may be presented indicating that the prior image data was out of focus, directed at the wrong portion of the secondary device and the like. An instructional message may be presented such as “Please obtain a closer photo of the front panel”, “Please obtain a photo of the identification tag or nameplate”, etc.

Returning to 506, when one or more device identifiers are identified, flow moves to 509. An optional operation may be provided at 509 where the user is permitted to select between multiple potential matches. For example, questions may be presented to the user regarding uncertainties resulting from the image recognition. For example, the image recognition may determine that a secondary device is from a particular manufacturer, but may not be able to identify the model number on the device. Accordingly, the base device may present, on the user interface, multiple model numbers to the user for selection therebetween. Additionally or alternatively, the user may be prompted to enter the model number. As a further option, the image recognition software may identify a limited set of potential matching secondary devices. When more than one potential secondary device is identified, the potential matches may be listed and the user is afforded the option to select between the potential secondary devices. For example, the image recognition software may identify a secondary device as a SONOS component, but may not be able to determine whether the SONOS component represents a standalone speaker, bridge, hub or other component. In the foregoing example, a list of the potential matching SONOS components may be displayed on the base device for the user to select between. Additionally or alternatively, the image recognition process may identify more than one secondary device as potential matches, and assign the different secondary devices to have different levels of match likelihood. For example, a TV video streaming device may be identified generally as the secondary device, but the image recognition software may not be able to identify the manufacturer of the device (e.g., Apple TV, Amazon Fire stick, Chrome Cast, etc.). The image recognition software may have a higher level of confidence that the streaming device represents an Apple TV device, and may have a lower level of confidence that the streaming device represents a Chrome Cast device. Accordingly, the Apple TV option may be listed first and the Chrome Cast option listed second, as well as other potential matches listed in an ordered priority, for the user to select between. At 510, the processor returns the device identifier, and the operations of FIG. 4 continue.

FIG. 6 illustrates a process for capturing and identifying communications data, as the target descriptive data, in accordance with embodiments herein. At 602, the base device transmits an inquiry request over one or more wired or wireless medium in connection with discovering local secondary devices that are in the proximity of the base device. At 604, the base device receives responses from the one or more secondary devices. The content and nature of the inquiry requests and responses may vary based upon various factors. For example, the requests and responses may be conveyed in accordance with the Bluetooth protocol. Optionally, the requests and responses may be conveyed in accordance with various wireless protocols, such as 802.11, wireless local area network (WLAN), Wi-Fi protected access (WPA), wired equivalent privacy (WEP), Wi-Fi, wireless broadband and the like. As other examples, the request and responses may be conveyed in accordance with various communications protocols, such as a hypertext transfer protocol (HTTP), Internet relay chat (IRC) and the like. Optionally, the communications data may be captured utilizing infrared, such as when the secondary device includes an IR transmitter. The base device may include an IR receiver that receives IR-based communications data.

At 606, the communications data is analyzed for information of interest. For example, the header portion of a response may be analyzed to identify device identifiers, such as the make and model of a secondary device.

At 608, the processor determines whether a device identifier was recognized from the communications data. When no device identifier is obtained, flow moves to 610, where a message is presented to inform the user that the capture operation is being repeated. By way of example, at 610, suggestions may be provided to the user to better facilitate the collection of communications data. For example, a message may be presented indicating that no responses were received and suggesting that the user ensure that the secondary device is turned on or within range. Optionally, the message may suggest some action to be taken at the secondary device, such as pressing a button, reposition the direction in which the secondary device faces, or making some other adjustment to the secondary device.

Returning to 608, when one or more devices is identified, flow moves to 612. An optional operation may be provided at 612 where the user is permitted to select between multiple potential matches. For example, questions may be presented to the user regarding uncertainties resulting from the device recognition. For example, the image recognition may determine that a secondary device is from a particular manufacturer, but may not be able to identify the model number on the device. Accordingly, the base device may present, on the user interface, various options for model numbers to the user for selection. Additionally or alternatively, the user may be prompted to enter the model number. As a further option, the image recognition may identify a limited set of potential matching secondary devices. Thereafter, at 614, the device identifier is returned, and the operations of FIG. 4 continue.

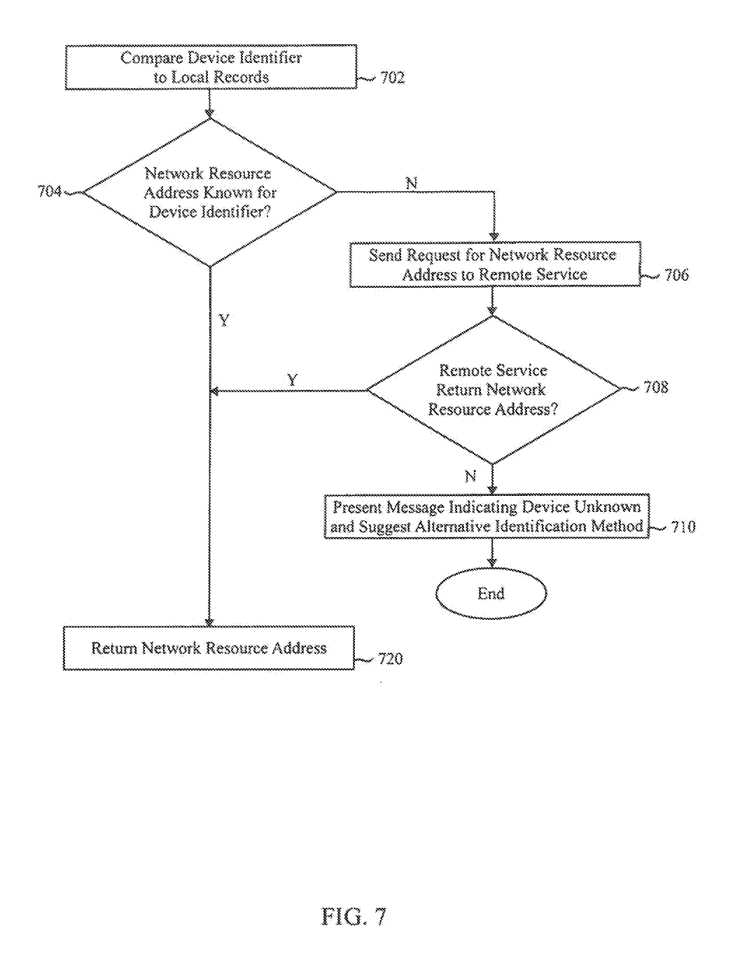

FIG. 7 illustrates a process for determining an address of a network resource that includes control content for a secondary device of interest in accordance with embodiments herein. At 702, the processor compares a device identifier to information stored in local records. For example, the base device may include a catalogue 222 correlating a plurality of device identifiers with addresses of corresponding network resources. For example, the catalogue 222 may list one or more URL addresses in connection with specific secondary devices. As another example, the processor may determine whether control content 220 is already stored on the base device that may be utilized with the secondary device. For example, control content 220 may be uploaded in connection with a prior secondary device which becomes disabled, discarded or otherwise unusable. When the user replaces the secondary device, the existing control content 220 may still be useful. Additionally or alternatively, the existing control content 220 may simply need to be updated or upgraded. In accordance there with, the processor determines that control content 220 already exist in the local storage medium 206 that may be utilized with the secondary device. Optionally, the processor may determine that, while one version of control content 220 already exist on the base device, an upgrade is necessary. Accordingly, the processor may initiate a network session to download and upgrade or update to the existing control content 220.

At 704, the processor determines whether a network resource address has been identified (from the comparison at 702) for the device identifier. When a network resource address is identified, the process moves to 720. Otherwise, other operations are performed in an effort to identify a network resource address. At 704, when no network resource address is identified, flow moves to 706.

At 706, the base device sends a request for a network resource address to a remote service. For example, in the embodiment of FIG. 1, the mobile device with send the request to a device management server 120. The request includes the device identifier, among other information. The device management server 120 compares the device identifier to a lookup table, database, or catalogue in search of a corresponding network resource address, and when one is identified, the address is returned to the base device. When no network resource address is identified, this information (e.g., “none found”) may also be returned to the base device. Additionally or alternatively, when no network resource address is identified, the device management server 120 may perform additional operations in search of an address. For example, the device management server 120 may identify a manufacturer, distributor or other entity that provides or maintains the secondary device. The device management server 120 may navigate to a service webpage maintained by the manufacturer, distributor or other entity (e.g., server 114) and search the service webpage for an address of a network resource at which control content is maintained. When the address of interest is identified, the device management server 120 returns the address to the base device.

At 708, the processor of the base device determines whether the remote service has returned a network resource address. If so, flow advances to 720. Otherwise, flow moves from 708 to 710. At 710, a message is presented to the user indicating that the secondary device is unknown. Optionally, alternative identification methods may be suggested to the user (e.g. taking a picture of the secondary device, speaking or typing in the make and model of the device, etc.).

At 720, the network resource address is returned to be used in connection with the operations of FIG. 4. As explained above in connection with FIG. 4, once the network resource address is known, a network session is initiated there with (at 408) and the control content of interest is downloaded (at 410).

Returning to the operations of FIG. 4, once control content 220 is downloaded, the control content may then be utilized to control one or more operations of a secondary device. For example, the control content may represent an application that is launched on a smart phone, tablet device, laptop computer or other electronic device, serving as a base device. Once the application is launched, a user may utilize the user interface of the base device to control operation of the secondary device. By way of example only, the application launched from the control content may provide control over a television, stereo, video streaming content device, home appliance, home security system and the like. Additionally or alternatively, the control content may enable video streaming between the base device and the secondary device. The control content when implemented on the base device may include any IR codes necessary to enable IR control by the base device over the secondary device. It is recognized that the foregoing are a non-limiting list of examples of potential operations that may be controlled or otherwise managed by a base device.

Before concluding, it is to be understood that although e.g. a software application for undertaking embodiments herein may be vended with a device such as the system 100, embodiments herein apply in instances where such an application is e.g. downloaded from a server to a device over a network such as the Internet. Furthermore, embodiments herein apply in instances where e.g. such an application is included on a computer readable storage medium that is being vended and/or provided, where the computer readable storage medium is not a carrier wave or a signal per se.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A computer implemented method, comprising:
under control of one or more processors configured with specific executable program instructions,
capturing target descriptive data utilizing a base device, where the target descriptive data is representative of a secondary device;
initiating a network session with a network resource;
downloading control content from the network resource to the base device; and
implementing the control content on the base device in connection with controlling one or more operations of the secondary device.

2. The method of claim 1, further comprising analyzing the target descriptive data to identify a device identifier indicative of the secondary device and indicative of the network resource having the control content.

3. The method of claim 2, wherein the analyzing includes determining, from the target descriptive data, the network resource.

4. The method of claim 2, wherein the analyzing includes transmitting a request to a remote device management server for an address of the network resource.

5. The method of claim 1, wherein the capturing of target descriptive data includes collecting image data representative of an image of the secondary device.

6. The method of claim 1, wherein the capturing of target descriptive data includes collecting communications data received from the secondary device.

7. The method of claim 1, wherein the control content includes an application that, while operated on the base device, enables control over the secondary device.

8. The method of claim 1, wherein the analyzing includes utilizing a catalog of network resource addresses to identify the one or more network resources.

9. A device, comprising:
a processor;
a memory storing program instructions accessible by the processor;
wherein, responsive to execution of the program instructions, the processor performs the following:
capture target descriptive data utilizing a base device, where the target descriptive data is representative of a secondary device;
initiate a network session with a network resource;
download control content from the network resource to the base device; and
implementing the control content on the base device in connection with controlling one or more operations of the secondary device.

10. The device of claim 9, further comprising a camera that captures image data representative of the secondary device, the image data corresponding to the target descriptive data.

11. The device of claim 9, further comprising a transceiver configured to transmit a inquiry request and to receive a response from the secondary device, the processor analyzing the response to obtain communications data corresponding to the target descriptive data.

12. The device of claim 9, wherein the processor analyzes the target descriptive data to identify a device identifier indicative of the secondary device and indicative of the network resource having the control content.

13. The device of claim 9, wherein the processor determines, from the target descriptive data, the one or more network resources that include the control content.

14. The device of claim 9, further comprising a transceiver configured to transmit a request to a remote device management server for an address of the one or more network resources.

15. The device of claim 9, wherein the memory stores the control content including an application that, while operated by the processor, enables control over the secondary device.

16. The device of claim 9, wherein the memory stores a catalog of network resource addresses, the processor utilizing the catalog to identify the one or more network resources.

17. A computer program product comprising a non-signal computer readable storage medium comprising computer executable code to:
capture target descriptive data utilizing a base device, where the target descriptive data is representative of a secondary device;
initiate a network session with a network resource;
download control content from the network resource to the base device; and
implement the control content on the base device in connection with controlling one or more operations of the secondary device.

18. The computer program product of claim 17, wherein the computer executable code further comprising analyzing the target descriptive data to identify a device identifier indicative of the secondary device and indicative of the network resource having the control content.

19. The computer program product of claim 18, wherein the analyzing includes determining, from the target descriptive data, the one or more network resources that include the control content.

20. The computer program product of claim 17, further comprising the control content that includes an application that, while operated on the base device, enables control over the secondary device.
